(19) United States
(12) Patent Application Publication
(10) Pub. No.: US 2011/0135233 A1
(43) Pub. Date: Jun. 9, 2011

(54) APPARATUS WITH SECONDARY LOAD PATH FOR VEHICLE WHEEL BEARING ASSEMBLY

(75) Inventors: Robert G. Sutherlin, Canton, MI (US); Douglas N. Reed, Milford, MI (US)

(73) Assignee: GM GLOBAL TECHNOLOGY OPERATIONS, INC., Detroit, MI (US)

(21) Appl. No.: 12/872,421

(22) Filed: Aug. 31, 2010

Related U.S. Application Data
(60) Provisional application No. 61/266,723, filed on Dec. 4, 2009.

(51) Int. Cl. F16C 33/58; F16C 19/04

(52) U.S. Cl. 384/513; 384/456; 384/569

(57) ABSTRACT

An apparatus is provided for a vehicle having a wheel and a wheel bearing assembly with bearing races supporting the wheel. The apparatus includes a first component mounted for rotation with the wheel and a second component spaced from the first component by a predetermined gap and not connected for rotation with the wheel. One of the first and the second components is displaced relative to the other upon a force to close the gap and contact the other of the first and second components to at least partially form a load path for the force that bypasses the bearing races.

### CROSS-REFERENCE TO RELATED APPLICATIONS

This application claims the benefit of U.S. Provisional Patent Application No. 61/266,723, filed Dec. 4, 2009, and which is hereby incorporated by reference in its entirety.

### TECHNICAL FIELD

The invention relates to an apparatus that provides a load path for a lateral force applied to a vehicle wheel assembly to prevent excessive deformation of bearing races.

### BACKGROUND OF THE INVENTION

A lateral load on a vehicle wheel, such as by a curb impact, is typically borne along a load path through the rolling elements and bearing races of the wheel bearing assembly. The rolling elements and bearing races are designed to handle these lateral forces without causing excessive plastic deformation of the races, referred to as Brinell damage, as excessive plastic deformation can result in bearing vibration and noise. Typical solutions implemented to prevent excessive Brinell damage include increasing the size of the bearings and surrounding brake corner components. However, this increases component weight. Tapered bearings are sometimes used as they have a greater contact area with the races and thus can dissipate a greater load. However, tapered bearings have higher drag, reducing vehicle efficiency. Some bearings are asymmetrical, having a first row of rolling elements of larger diameter or increased number than a second row of rolling elements. The increased number or size of bearing elements reduces the stress on each element. This design option also increases weight and cost, and requires redesign of the bearing races.

### SUMMARY OF THE INVENTION

A solution is provided that creates a secondary load path for loads resulting from a curb impact, a pothole, or off-road use, decreasing the load borne by a load path through the rolling elements and bearing races, thus preventing excessive Brinell damage. The solution does not add significant weight or component complexity. Specifically, an apparatus is provided for a vehicle having a wheel and a wheel bearing assembly with bearing races supporting the wheel. The apparatus includes a first component mounted for rotation with the wheel and a second component spaced from the first component by a predetermined gap and not connected for rotation with the wheel. One of the first and the second components is displaced relative to the other upon a force to close the gap and contact the other of the first and second components to at least partially form a load path for the force. The load path is a secondary load path that bypasses the bearing races, preventing excessive plastic deformation of the races. Some loading is still via the initial load path through the races, but the secondary, parallel load path prevents any significant increase in stress on the races.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross-sectional illustration of a portion of a vehicle having a wheel bearing assembly with wheel races and a first embodiment of an apparatus configured to provide a secondary load path, shown prior to an applied force;

FIG. 2 is a schematic cross-sectional illustration of the portion of the vehicle of FIG. 1 after the applied force, showing the secondary load path formed that bypasses the wheel bearing races;

FIG. 3 is a schematic cross-sectional illustration of a portion of a vehicle having a wheel bearing assembly with wheel races and a second embodiment of an apparatus configured to provide a secondary load path, shown during an applied force;

FIG. 4 is a schematic illustration in top view of a third embodiment of an apparatus to provide a secondary load path through a brake caliper bracket and a brake rotor that bypasses the wheel bearing races, shown prior to an applied force;

FIG. 5 is a schematic illustration partial cross-sectional side view of a fourth embodiment of an apparatus to provide a secondary load path through a brake caliper and a brake rotor that bypasses wheel bearing races, shown prior to an applied force;

FIG. 6 is a schematic illustration partial cross-sectional side view of a fifth embodiment of an apparatus to provide a secondary load path through a steering knuckle and a brake rotor that bypasses wheel bearing races; and

FIG. 7 is a schematic cross-sectional illustration of a portion of a vehicle having a wheel bearing assembly with wheel races and tapered rolling elements and a fifth embodiment of an apparatus configured to provide a secondary load path, shown prior to an applied force.

### DESCRIPTION OF THE PREFERRED EMBODIMENTS

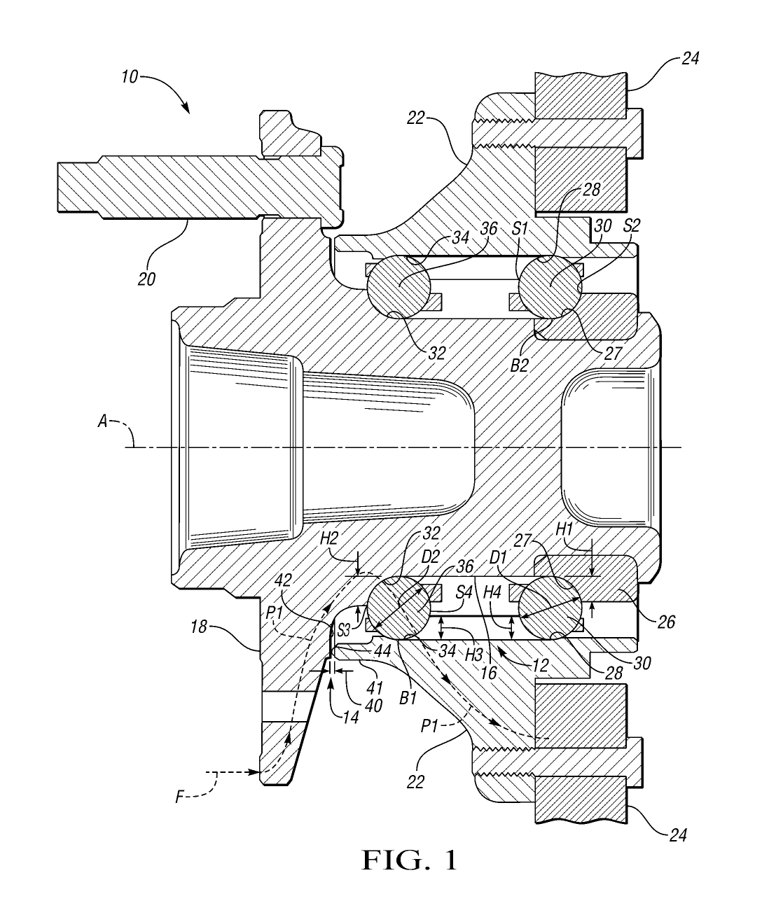

Referring to the drawings, wherein like reference numbers refer to like components throughout the several views, FIG. 1 shows a portion of a vehicle 10 with a wheel bearing assembly 12 for supporting a wheel (not shown). An apparatus 14 is provided that forms a secondary load path during an applied force, such as a force resulting from a curb impact, a pothole, or off-road use, to reduce the load borne by the wheel bearing assembly 12, thereby improving the Brinell performance of the bearing assembly 12, as further described below.

The bearing assembly 12 includes a rotatable wheel hub 16 having a flange 18 to which a wheel is mounted by fasteners 20 (one shown) as is known. Wheel hub 16 is also referred to as a wheel mounting component. The wheel hub 16 rotates about axis A. The bearing assembly 12 also includes a bearing outer ring 22 adapted to be fastened or otherwise secured to vehicle suspension structure 24 such that it is substantially nonrotatable about axis A.

The bearing assembly 12 has an annular inner bearing ring 26 secured for rotation with the wheel hub 16 and defining an inner bearing race 27. An outer bearing race 28 is defined by the bearing outer ring 22. The bearing races 27, 28 support a first set of rolling elements 30 that aid in rotation of the wheel hub 16 relative to the bearing outer ring 22. The wheel hub 16 defines another inner bearing race 32 and the outer ring 22 defines another outer bearing race 34. A second set of rolling elements 36 are supported between the races 32, 34. The bearing races 27, 28 and rolling elements 30 are relatively inboard on the vehicle 10 and the bearing races 32, 34 and rolling elements 36 are relatively outboard on the vehicle 10. The rolling elements 30, 36 of this embodiment are balls. Accordingly, the bearing races 27, 28, 32 and 34 have generally arcuate profiles to allow low friction rotation of the rolling elements 30, 36. The outer races 28 and 34 have arcuate profiles with a base and a shoulder. The base is the portion of the arcuate profile furthest from the axis of rotation. For example, base B1 and shoulder S4 are shown on race 34. Base B2 and shoulder Si are shown on race 28.

As shown, the diameters D1, D2 of the respective rolling elements 30, 36 and the shoulder heights H1, H2, H3, H4 of the respective raceways 27, 28, 32, 34 are generally equal. However, the inboard rolling elements 30 and the outboard rolling elements 36 may be of different sizes. Additionally, the shoulder heights H1, H2, H3 and H4 may be different, as is known in the art. In some embodiments, the shoulder heights H1, H2, H3 and H4 are 30 to 50 percent of the respective diameters D1, D2 in order to prevent excessive stress concentrations in the hub 16 or outer ring 22, as can occur with low shoulder heights.

In the event that a tire rotating with a wheel on wheel hub 16 strikes a curb or other relatively low object with at least a partially lateral impact, hits a pothole, or is used off-road, a force, shown in FIG. 1 as an inboard-directed force F will be transmitted to the wheel hub 16. The force F is represented by an arrow acting directly on the wheel hub 16, although the force may occur below the level shown. Although shown as an inboard-directed force in FIG. 1, the force may be in any direction that includes a laterally inboard or laterally outboard component. In a typical wheel bearing assembly, the energy of the force will be absorbed along a first load path P1 represented by the phantom arrow shown in FIG. 1. Thus, the load is transmitted via the rolling elements 36 and the races 32, 34 from the wheel hub flange 18 to the outer bearing ring 22 and the suspension member 24. The representative force F causes a counterclockwise moment on the flange 18, displacing the hub 16 and raceways 32, 27 slightly inward relative to their position prior to application of the force. This can cause the points of contact of rolling elements 30, 36 to shift with respect to the races 27, 28, 32, 34, potentially all the way to the edges of the shoulders, resulting in stress concentrations at points S1, S2, S3, S4.

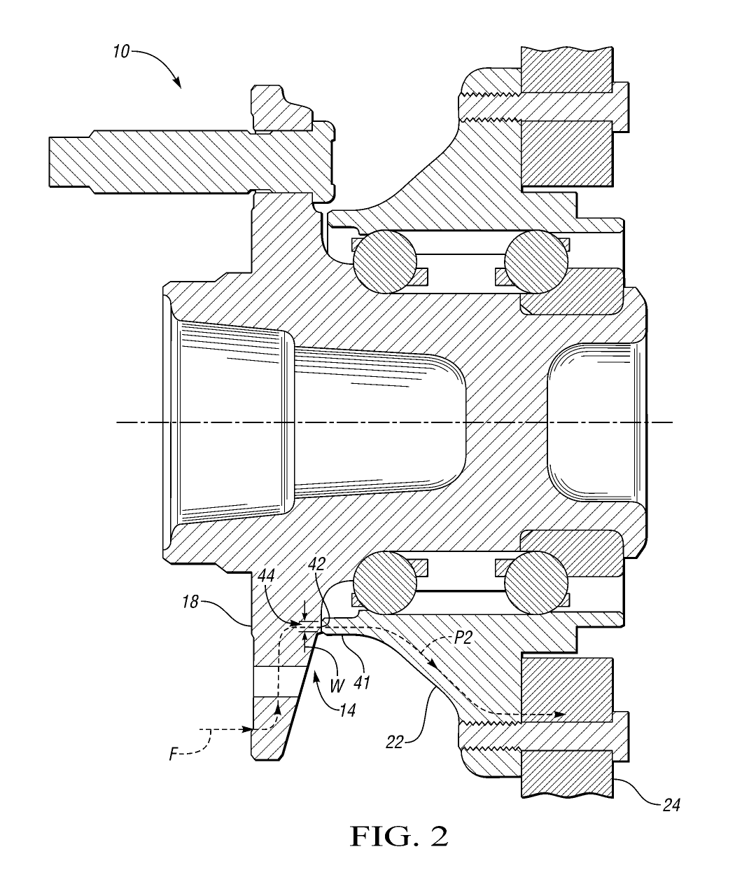

As discussed above, a typical bearing assembly is usually designed with large roller elements or tapered rolling elements to prevent Brinell damage. With the apparatus 14 of bearing assembly 12, however, a gap 40 (also referred to as a clearance) between an annular surface 42 of the flange 18 facing the outer ring 22 and an annular surface 44 of the outer ring 22 facing the flange 18 is controlled to a predetermined width to ensure that the surface 42 will contact the surface 44 at a predetermined level of force F, as shown in FIG. 2. Contact between the surfaces 42, 44 creates an alternative load path P2 shown in FIG. 2 from the flange 18 to the outer ring 22 to the suspension structure 24. Some of the load is carried along the secondary load path P2 that bypasses the rolling elements 30, 36 and races 27, 28, 32, 34, reducing the load that must be carried along the initial load path, preventing Brinell damage without requiring a larger bearing assembly or larger rolling elements.

In the embodiment of FIGS. 1 and 2, the gap 40 is created by extending a portion 41 of the outer ring 22 toward the flange 18. It should be appreciated that a shim could be secured to the outer ring 22 to extend toward the flange 18, creating the predetermined gap 40. The use of a shim to control the gap 40 allows retrofitting of existing bearing assemblies and designs to provide the secondary load path. Accordingly, the apparatus 14 includes the flange 18, and the extended portion 41 of the wheel hub 16 forming the predetermined gap 40.

The size of the gap 40 is partially dependent upon the distance of the intended area of contact (between surfaces 42, 44) from the axis A, as movement of the flange 18 in a lateral direction increases as distance from axis A increases. Testing has shown that for a bearing assembly having an outer ring 22 with an effective diameter of 80 mm, a gap 40 of 0.4 mm provides some improvement in Brinell performance and a gap of 0.3 mm provides substantial improvement in preventing Brinell damage to the races 27, 28, 32, 34. The gap 40 must be large enough to avoid unintended contact between the surfaces 42, 44 during high speed turns of the wheel, or during high G turns below a certain magnitude.

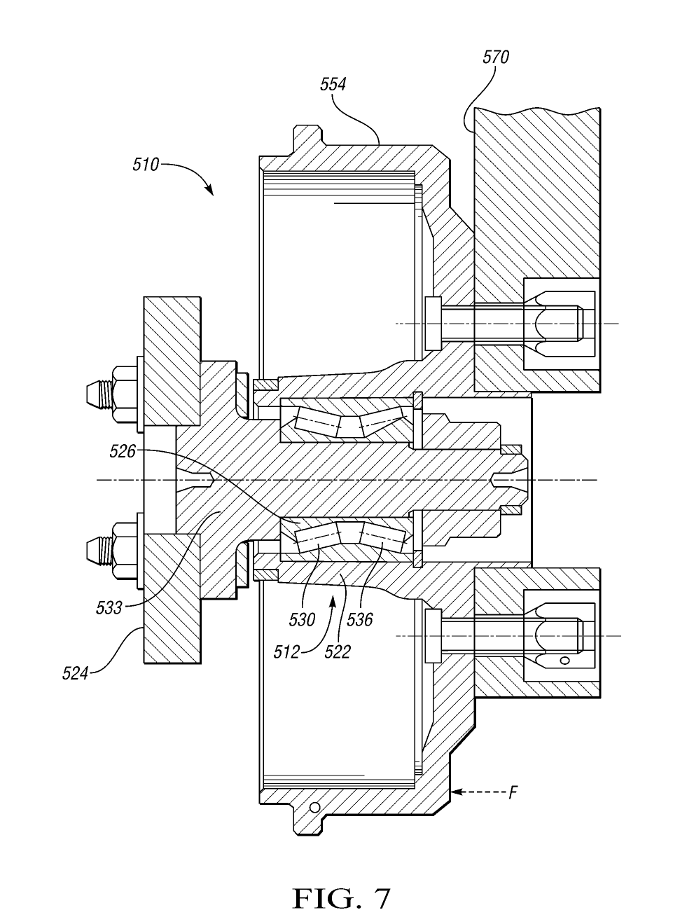

The radial width W of the area of contact between the surfaces 42, 44 should be wide enough to avoid creating excessive stress in the extended portion 41. For a bearing assembly with an effective outer ring diameter of 80 mm. a radial width W of about 2 mm to 5 mm is sufficient. As is known in the art, it is preferred that the shoulder heights H1, H2, H3, H4 of the races are greater than about 30% and less than about 50% of the diameters D1, D2 of the rolling elements 30, 36. It is preferred that the slight shift of the point of contact of the rolling elements 30, 36 along the races 27, 28, 32, 34 is limited to a change in height of the points of contact above the base of the races along the race profiles of not more than about 35% of the diameter of the balls. It should be appreciated that, although the rolling elements 30, 36 are shown having the same diameter D1, D2, they could have different diameters. For example, wheel bearings in which the diameter of the outboard rolling elements 36 have a larger diameter than the inboard rolling elements 30 are well known. Furthermore, the rolling elements 30, 36 may be different types. For example, the outboard rolling elements 36 could be tapered bearings (discussed with respect to FIG. 7) while the inboard rolling elements 30 are ball-type bearings. Tapered bearings generally disperse force over a wider area of contact with the bearing races, allowing greater loading without excessive stress concentration.

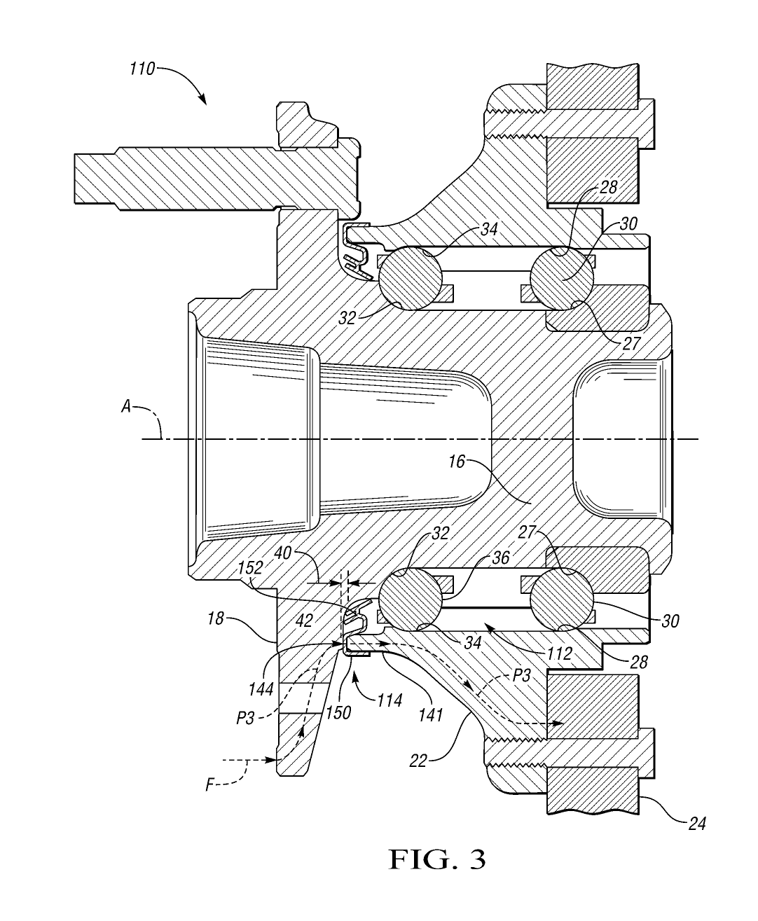

Referring to FIG. 3, another embodiment of a vehicle 110 has a bearing assembly 112 configured with a different apparatus 114 that provides a secondary load path upon application of a sufficient force F to the flange 18 of the wheel hub 16, such as by a curb impact. Components configured substantially identically to those in FIGS. 1 and 2 are referred to with like reference numbers and function as described with respect to FIGS. 1 and 2. The apparatus 114 includes a shim 150 secured to an end of extension portion 141 of the outer ring 22. The shim 150 is a portion of a seal casing that includes a seal 152 integrally connected to the shim 150 to prevent dirt and debris from reaching the bearing assembly 112. Alternatively, a seal may be provided that is not integral with the shim 150. In that case, the seal may be a simpler L-shape in cross-section.

Prior to application of a sufficient force F, a predetermined gap 40 exists between the surface 42 of the flange 18 and an outer surface 144 of the shim 150 facing surface 42. Force applied to the flange 18 less than a predetermined magnitude will cause energy to be absorbed along a load path the same as load path P1 of FIG. 1. FIG. 3 shows the position of the flange 18 after application of at least the force F of a predetermined magnitude that causes inboard displacement of the flange 18 to close the gap 40, with surface 42 contacting surface 144, forming a secondary load path P3. Load path P3 transfers the force Fl through the flange 18, shim 150 and outer ring 22 to the vehicle suspension structure 24, bypassing the rolling elements 30, 36 and races 27, 28, 32, 34, reducing the load that would otherwise be carried by the initial load path. Excessive stress of the races 27, 28, 32, 34 is prevented, and Brinell performance is improved. It is noted that the upper portion of the shim 150 (above axis A) is shown in contact with the upper portion of the hub 22 in FIG. 3. However, subject to the placement of the force F, contact between the flange 18 and the shim 150 will likely occur only in the lower half of the shim 150, closer to a typical area where force is applied, such as by a curb impact.

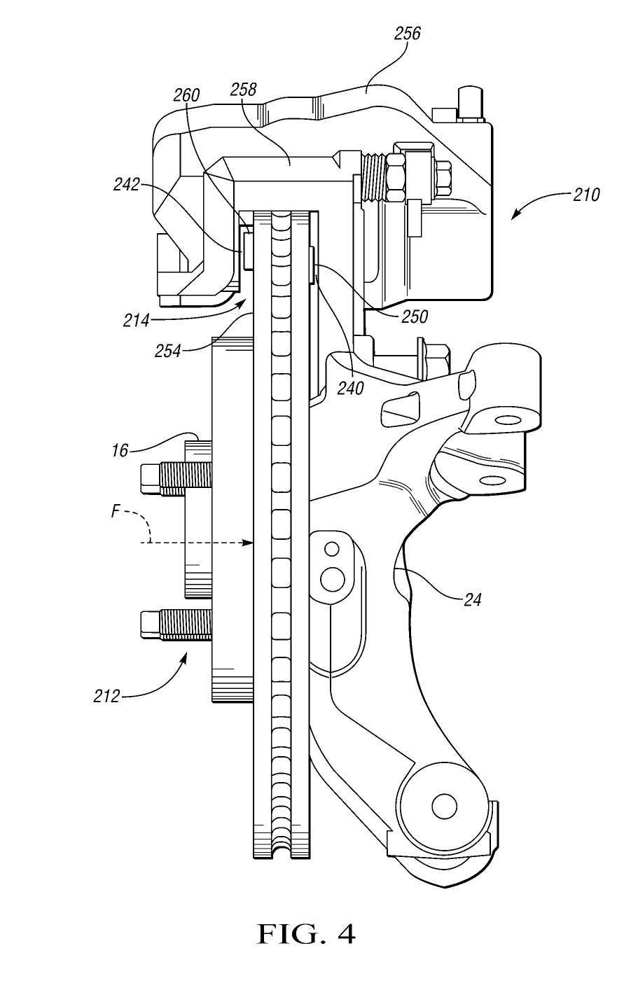

Referring to FIG. 4, a corner assembly portion of another vehicle 210 is shown from above, with the vehicle suspension structure 24 of FIGS. 1-3 shown in greater detail. The bearing assembly 212 includes rotatable hub 16 and outer ring 22 (not visible) as described with respect to FIG. 1-2. A brake assembly is shown with brake rotor 254 connected for rotation with the hub 16, a brake caliper 256 secured to the vehicle suspension structure 24, and a floating-type brake caliper bracket 258.

An apparatus 214 is provided that creates a secondary load path upon application of a sufficient force. The secondary load path bypasses the races of the bearing assembly 212. Much of the bearing assembly 212 is not visible in the plan view of FIG. 4; however, bearing assembly 212 is identical to bearing assembly 12 of FIGS. 1-2. The apparatus 214 includes an extension 250, which may be a shim or nub, at a lower portion (below the axis of rotation) of the inboard side of the rotor 254, extending inboard toward the caliper bracket 258. The apparatus 214 further includes an extension 260, which may be a shim or nub, placed relatively high (above the axis of rotation) on an outboard side of the rotor 254 and extending outward from an upper portion of the rotor 254 toward the caliper bracket 258. In the overhead view of FIG. 4, both extensions 250, 260 appear to be at the same level; however, extension 260 is higher than extension 250.

Upon application of the force F, a moment is created on the wheel hub 16 that causes movement of the wheel hub 16 and the rotor 254 to close a predetermined gap 240 normally existing between the extension 250 and the caliper bracket 258, with the extension 250 contacting the caliper bracket 258. (The force F is shown in phantom, applied to a lower portion of the rotor 254 below the hub 16 that is not visible in FIG. 4.) Furthermore, a gap 242 is closed between the extension 260 and the caliper bracket 258. Thus, a secondary load path is created from the rotor through the extensions 250, 260 to the brake caliper bracket 258, to the attached suspension structure 24. The gaps 240, 242 are of predetermined sizes based on their relative distances from the axis of rotation of the bearing assembly 212 so that they will be closed by displacement of the rotor 254 and establish the secondary load path upon a sufficient force F, thus preventing excessive Brinell damage to the races of the bearing assembly 212. When an applied force is less than a predetermined amount, the gaps 240, 242 do not close, and the entire load is carried through the load path that passes through the bearing assembly 212.

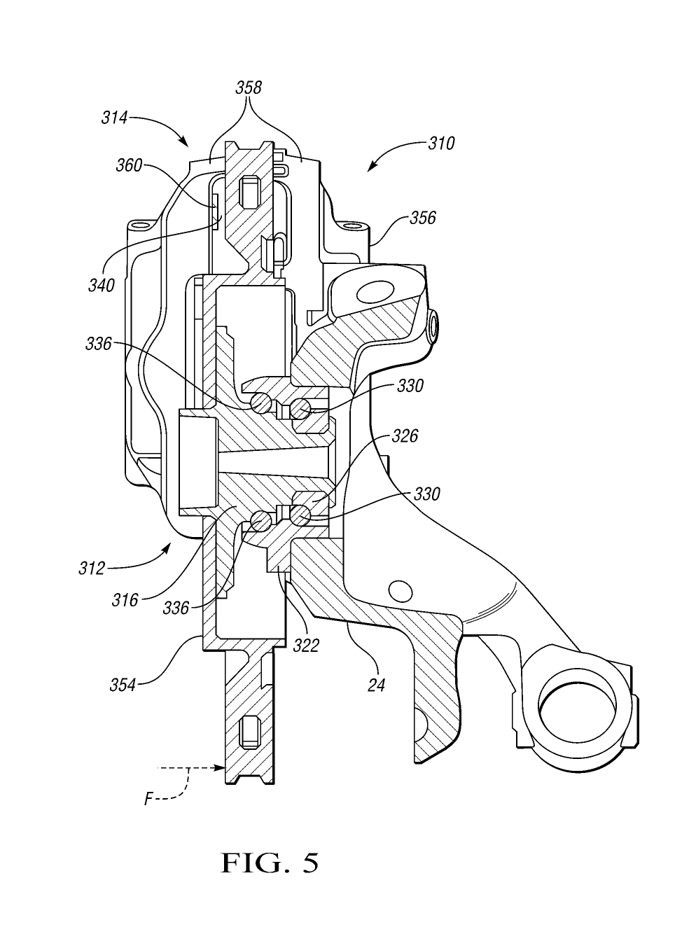

Referring to FIG. 5, a corner assembly portion of another vehicle 310 is shown in a cross-sectional side view, with the vehicle suspension structure 24 of FIGS. 1-3 shown in greater detail. A bearing assembly 312 has a rotatable hub 316 to which the wheel (not shown) is connected for rotation, as is known. The bearing assembly 312 also has an outer ring 322 fixed to the suspension structure 24. Rolling elements 330, 336 roll along races visible in FIG. 5 formed by the outer ring 322, the hub 316 and an inner ring 326.

A brake assembly is shown with brake rotor 354 connected for rotation with the hub 316, a brake caliper 356 secured to the vehicle suspension structure 24, and a brake caliper bracket 358. An apparatus 314 is provided that creates a secondary load path upon application of sufficient force F. The secondary load path bypasses the races of the bearing assembly 312. The apparatus 314 includes an extension 360, which may be a shim or nub, placed relatively high (above the axis of rotation) on the brake caliper bracket 358 outboard of the brake rotor 354 and extending inward toward the brake rotor 354. The extension 360 is configured to form a predetermined gap 340 between the extension 360 and the brake rotor 354. Another extension, shim or nub is placed relatively low on the brake caliper bracket 358, inboard of the brake rotor 354 and extends outward toward the brake rotor 354 to form another predetermined gap between the brake caliper bracket 358 and the rotor 354. This extension is not visible in FIG. 5, as it is behind the hub 316 on the inboard portion of the brake caliper bracket 358.

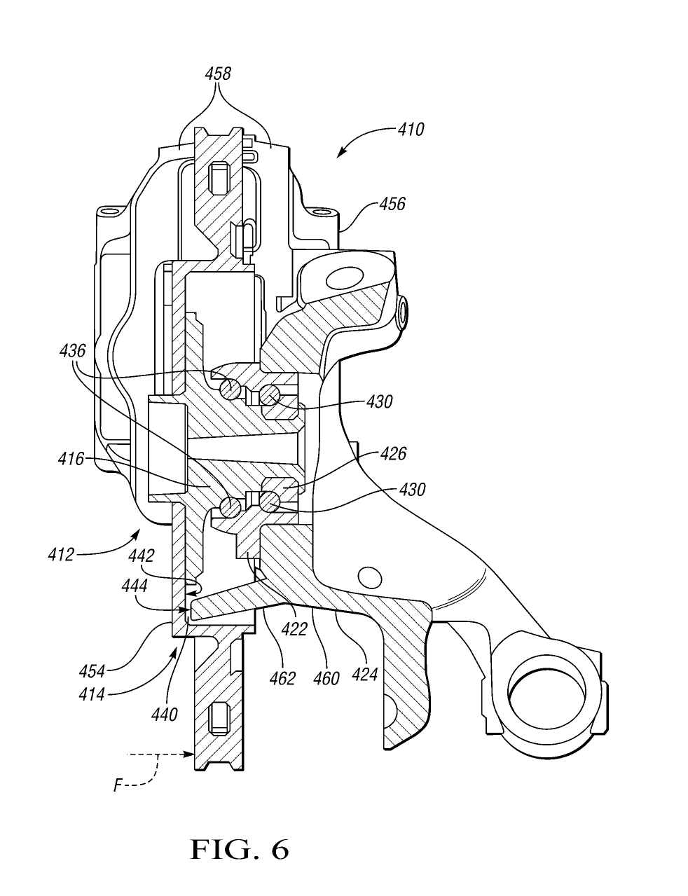

Referring to FIG. 6, a corner assembly portion of another vehicle 410 is shown in a cross-sectional side view. A bearing assembly 412 is provided that is substantially identical to bearing assembly 312 as described with respect to FIG. 5. A brake rotor 454, brake caliper bracket 458 and brake caliper 456 are as described with respect to like components of FIG. 5, except that the brake caliper bracket 458 is not configured with extensions, shims or nubs to create a secondary load path. The bearing outer ring 422 and caliper bracket 456 are secured to suspension structure 424. Rolling elements 430, 436 roll along races visible in FIG. 6 formed by the outer ring 422, the hub 416 and an inner ring 426.

An apparatus 414 creating a secondary load path as discussed below is provided by an extension 462 of a steering knuckle 460 or other portion of the suspension structure 424 that is sized to create a predetermined gap 440 between an inboard facing surface 442 of the brake rotor 454 and an outboard facing surface 444 of the extension 462.

Under normal vehicle operating conditions, including high speed G turns below a certain magnitude and other events that generate a force F less than a predetermined amount, the gap 440 is at least partly maintained and the surfaces 442, 444 do not contact one another. Thus, a load path for such low level curb events is carried from the rotor 454 through the hub 16, rolling elements 430, 436, and bearing races to the outer ring 422 and suspension structure 424.

When an applied force F reaches a predetermined level, the apparatus is configured so that inboard movement of the rotor 454 caused by a clockwise moment on the rotor 454 due to the force F will cause surface 442 to contact surface 444. The secondary load path is thus created from the rotor 454 to the extension 462 and suspension structure 424 that bypasses the bearing 412, carrying some of the load in parallel with a portion of the load carried along the initial load path through the races, thus preventing Brinell damage to the bearing races.

Referring to FIG. 7, a portion of a vehicle 510 includes a secondary type of bearing 512 that has rolling elements that are tapered bearings, with both an inboard row of tapered bearings 530 and an outboard row of tapered roller bearings 536. Inner races of the bearing assembly 512 are formed by an inner ring 526 integral with or attached to a stationary shaft 533 connected to vehicle suspension structure 524. Outer races of the bearing assembly 512 are formed by an outer ring 522 attached for rotation with the rotor 554 and the vehicle wheel 570. An apparatus to create a secondary load path upon application of a predetermined force F may be by any of the structures described above to create a predetermined gap that closes upon application of at least the predetermined force, such as by controlling a gap between the rotor 554 and an extension from the suspension structure 524, or by controlling a gap between the rotor and a brake caliper or brake caliper bracket. Although tapered bearings are shown only in the bearing assembly 512 of FIG. 7, any of the bearing assemblies described herein may have tapered bearings, a combination of a row of tapered bearings and a row of ball bearings, rows with differently-sized tapered or ball bearings, several rows of bearings, or any other bearing configuration known in the art.

While the best modes for carrying out the invention have been described in detail, those familiar with the art to which this invention relates will recognize various alternative designs and embodiments for practicing the invention within the scope of the appended claims.

1. A bearing assembly comprising
a rotating component defining an axis;
a non-rotating component fixed with respect to a vehicle suspension structure; and
bearing elements rotatably coupling the wheel mounting component to the non-rotating component to allow the wheel mounting component to rotate relative to the non-rotating component about the axis;
wherein the bearing elements include a first outer raceway and a first inner raceway, the first raceways rollably retaining a plurality of first rolling elements,
wherein an annular portion of the wheel mounting component is spaced axially from a non-rotating annular surface fixed with respect to the vehicle suspension structure in an outboard direction by a clearance so that, in the event of a sufficient side impact to the wheel mounting component, the wheel mounting component is configured to move into contact with the non-rotating annular surface and transmit a part of a resulting impact load to the vehicle suspension structure through the non-rotating annular surface, and
wherein the assembly is configured so that at least substantially any side impact to the wheel mounting component that is insufficient to cause the wheel mounting component to contact and transmit a load to the vehicle suspension structure through the non-rotating annular surface is also insufficient to cause the first rolling elements to impact and damage the first raceways and generate a noise or vibration condition when the wheel mounting component rotates relative to the non-rotating component.

2. The bearing assembly of claim 1, wherein the non-rotating annular surface is an annular surface of the non-rotating component.

3. The bearing assembly of claim 1, wherein the non-rotating annular surface is an annular surface of the vehicle suspension structure.

4. The bearing assembly of claim 1, wherein the first raceways are outboard raceways, the first rolling elements are outboard rolling elements, and the bearing assembly further comprises inboard outer and inner raceways displaced from the outboard raceway in the inboard direction, the inboard raceways rollably retaining a plurality of inboard rolling elements;
wherein the assembly is configured so that at least substantially any side impact to the wheel mounting component that is insufficient to cause the wheel mounting component to contact and transmit a load to the vehicle suspension structure through the non-rotating annular surface is also insufficient to cause the inboard rolling elements to impact and damage the inboard raceways and generate a noise condition when the wheel mounting component rotates relative to the non-rotating component.

5. The bearing assembly of claim 1, wherein the annular portion of the wheel mounting component is configured to contact the non-rotating annular surface at a generally arcuate contact area having a radial width from about 2 millimeters to about 5 millimeters.

6. The bearing assembly of claim 1, wherein the first outer raceway is fixed with respect to the non-rotating component and the first inner raceway is fixed with respect to the wheel mounting component.

7. The bearing assembly of claim 1, wherein the first outer raceway is fixed with respect to the wheel mounting component and the first inner raceway is fixed with respect to the non-rotating component.

8. The bearing assembly of claim 1, wherein the rolling elements are balls.

9. The bearing assembly of claim 1, wherein the rolling elements are tapered rollers.

10. The bearing assembly of claim 8, wherein each first raceway has a shoulder height of from about 30% to about 50% of the diameter of the balls.

11. The bearing assembly of claim 4, wherein the outboard rolling elements are one type of rolling element selected from the group consisting of tapered rollers and balls, and the inboard rolling elements are the other type of rolling element selected from the group consisting of tapered rollers and balls.

12. A bearing assembly comprising
a wheel mounting component defining an axis;
a non-rotating component fixed with respect to a vehicle suspension structure; and
bearing elements rotatably coupling the wheel mounting component to the non-rotating component to allow the wheel mounting component to rotate relative to the non-rotating component about the axis;
wherein the bearing elements include a first outer raceway and a first inner raceway, the first raceways rollably retaining a plurality of first rolling elements,
wherein a non-rotating annular surface fixed with respect to the vehicle suspension structure is spaced axially in an inboard direction from an annular portion of the wheel mounting component by a clearance of at most about 0.30 millimeter and configured to at least substantially prevent further inboard displacement of the annular portion of the wheel mounting component when the annular portion of the wheel mounting component is moved into contact with the non-rotating annular surface,
wherein the annular portion of the wheel mounting component is configured so that a sufficient side impact to the wheel mounting component in the inboard direction will cause the annular portion of the wheel mounting component to move into contact with the non-rotating annular surface,
wherein, when the wheel mounting component is not in contact with the non-rotating annular surface, the wheel mounting component is configured to transmit at least a portion of a side impact load to the first rolling elements and the first raceways, and
wherein, when the wheel mounting component is in contact with the non-rotating annular surface, the wheel mounting component is configured to transfer at least a portion of any additional side impact load to the vehicle suspension structure through the non-rotating annular surface.

13. The bearing assembly of claim 12, wherein the non-rotating annular surface is an annular surface of the non-rotating component.

14. The bearing assembly of claim 12, wherein the non-rotating annular surface is an annular surface of the vehicle suspension structure.

15. The bearing assembly of claim 12, wherein the first raceway is an outboard raceway, the first rolling elements are outboard rolling elements, and the bearing assembly further comprises inboard outer and inner raceways displaced from the outboard raceways in the inboard direction, the inboard raceways rollably retaining a plurality of inboard rolling elements.

16. The bearing assembly of claim 12, wherein the annular portion of the wheel mounting component is configured to contact the non-rotating annular surface at a generally arcuate contact area having a radial width from about 2 millimeters to about 5 millimeters.

17. The bearing assembly of claim 12, wherein the first outer raceway is fixed with respect to the non-rotating component and the first inner raceway is fixed with respect to the wheel mounting component.

18. The bearing assembly of claim 12, wherein the first outer raceway is fixed with respect to the wheel mounting component and the first inner raceway is fixed with respect to the non-rotating component.

19. The bearing assembly of claim 12, wherein the rolling elements are balls.

20. The bearing assembly of claim 12, wherein the rolling elements are tapered rollers.

21. The bearing assembly of claim 19, wherein each first raceway has a shoulder height of from about 30% to about 50% of the diameter of the balls.

22. The bearing assembly of claim 15, wherein the outboard rolling elements are one type of rolling element selected from tapered rollers and balls, and the inboard rolling elements are the other type of rolling element selected from tapered rollers and balls.

23. A bearing assembly comprising
a wheel mounting component defining an axis;
a non-rotating component fixed with respect to a vehicle suspension structure; and
bearing elements rotatably coupling the wheel mounting component to the non-rotating component to allow the wheel mounting component to rotate relative to the non-rotating component about the axis;
wherein the bearing elements include an outer raceway and an inner raceway that are at least substantially coaxial with the wheel mounting component, each raceway having an arcuate profile varying in distance from the axis of the wheel mounting component,
the outer raceway having a base at a lowest point on its arcuate profile furthest from the axis of the wheel mounting component and a shoulder at a highest point on its arcuate profile closest to the axis of the wheel mounting component,
the inner raceway having a base at a lowest point on its arcuate profile closest to the axis of the wheel mounting component and a shoulder at a highest point on its arcuate profile furthest from the axis of the wheel mounting component,
the raceways rollably retaining a plurality of balls,
wherein the wheel mounting component is operatively engaged to the balls so that inboard displacement of the wheel mounting component causes a point of contact between at least one of the balls and at least one of the raceways to be displaced higher along the arcuate profile of the at least one of the raceways,
wherein a non-rotating annular surface fixed with respect to the vehicle suspension structure is spaced axially in an inboard direction from an annular portion of the wheel mounting component by a clearance,
wherein the annular portion of the wheel mounting component is configured so that a sufficient side impact to the wheel mounting component in the inboard direction will cause the annular portion of the wheel mounting component to move into contact with the non-rotating annular surface, and
wherein the non-rotating annular surface is configured to at least substantially prevent further inboard displacement of the annular portion of the wheel mounting component when the annular portion of the wheel mounting component is moved into contact with the non-rotating annular surface and to at least substantially prevent displacement of the point of contact between the at least one of the balls and the at least one of the raceways to a height above the base of the arcuate profile greater than about 35% of the diameter of the balls.

24. An apparatus for a vehicle having a wheel and a wheel bearing assembly with bearing races supporting the wheel for rotation, comprising:
a first component mounted for rotation with the wheel;
a second component spaced from the first component by a predetermined gap and not connected for rotation with the wheel;
wherein one of the first and the second components is displaced relative to the other upon application of a force to close the gap and contact the other of the first and second components to at least partially form a load path that bypasses the bearing races.

25. The apparatus of claim 24, wherein the first component is a brake rotor and the second component is one of a brake caliper and a brake caliper bracket.

26. The apparatus of claim 24, wherein the first component is a brake rotor and the second component is a steering knuckle.

27. The apparatus of claim 24, wherein the first component is a portion of a wheel hub and the second component is a wheel bearing outer ring.
